(19) United States
(12) Patent Application Publication
(10) Pub. No.: US 2025/0356244 A1
(43) Pub. Date: Nov. 20, 2025

(54) CHATBOT FOR MENTAL HEALTH USING GENERATIVE ARTIFICIAL INTELLIGENCE AND SYSTEM FOR RECOGNITION AND RECOMMENDATION

(71) Applicant: VINBRAIN JOINT STOCK COMPANY, Hanoi (VN)

(72) Inventors: Steven Q. H. Truong, Hanoi (VN); Hoang Nguyen Ngoc, Hanoi (VN); Huong Nguyen Thi, Hanoi (VN); Hoang Nguyen Viet, Hanoi (VN); Chuong Chu The, Hanoi (VN); Giap Duong Quy, Hanoi (VN); Sinh Luu Truong, Hanoi (VN); Minh Le Thi Nguyet, Hanoi (VN); Anh Pham Hong, Hanoi (VN)

(21) Appl. No.: 18/664,210

(22) Filed: May 14, 2024

(51) Int. Cl. G06N 20/00; G06F 40/35

(52) U.S. Cl. CPC G06N 20/00; G06F 40/35

(57) ABSTRACT

A method for developing a chatbot for mental health using generative Artificial Intelligence (genAI) and a system for recognition and recommendation are disclosed. The method comprises: designing a conversation flow, creating a flowchart that outlines the logical steps; defining guiding questions and the Depression, Anxiety, and Stress Scale (DASS) examination; fine-tuning large language models with the technical prompt engineering; collecting and labeling data for each model mental health issues detection: ill-being detection model and keyword recognition model; building pipeline and training Artificial Intelligent (AI) model for ill-being detection model and keyword recognition model with a Bidirectional Encoder Representations from Transformers (BERT) model or a pre-train model; collecting and processing mental health support resources such as Cognitive Behavioral Therapy (CBT) exercises, informative articles, inspiring movies, and effective coping strategies, and psychologists; developing mental health support resources system; and developing and integrating speech-to-text and text-to-speech models into the system.

### TECHNICAL FIELD

The present invention generally relates to the fields of Artificial Intelligence and Machine Learning, specifically, to a method for developing a chatbot for mental health using generative Artificial Intelligence (GenAI) and a system for recognition and recommendation.

### BACKGROUND

Global mental health is a pressing issue, impacting millions silently. According to the World Health Organization (WHO), 1 in 4 people will face a mental disorder, with depression and anxiety being the most prevalent. In 2020, 264 million people dealt with depression and 300 million with anxiety. Tragically, nearly 800,000 people succumb to suicide yearly-one every 40 seconds. It's the second-leading cause of death globally for 16-29 year-olds. In Vietnam, suicides outnumber annual deaths by over 2.5 times. However, accessing professional help is often limited and costly, leaving many isolated and overwhelmed.

Chatbots are language-processing computer programs that can process language and simulate human-like responses. Chatbots are designed to replace human assistants in some client interactions with their natural language comprehension. Chatbots operate from an extensive knowledge base, allowing the AI program to be integrated into various areas. The complexities and abilities of chatbots span a wide range, some are designed to answer simple queries and others are intelligent enough to operate as virtual assistants that can personalize users' information. Many different types of chatbot systems can be utilized in the field of healthcare services, and they have different ways of implementing and functioning and different capabilities.

There are a few well-known AI-based chatbots in the field of mental healthcare services. Aside from the advantages that these programs provide, there are still several disadvantages that prevent them from effectively helping users with their mental problems, particularly when it comes to diagnosing users' complex emotional and mental health problems.

Those AI-driven approaches may be less effective than a combination of AI and human intervention, particularly for users with severe mental health issues that require professional care. The invention presents an innovative approach that addresses the full spectrum of mental health concerns, from early detection of mental health issues to providing adequate mental health support solutions by utilizing natural language processing and deep learning techniques to understand and respond to users' emotions.

### SUMMARY

The present invention discloses a method for using a chatbot for early detection, personalized self-healing guidance, and mental health resources to overcome this problem. The chatbot utilizes voice and text, employing unique 3-layer Artificial Intelligence/Machine Learning (AI/ML) algorithms that adapt to user interaction, leading to tailored recommendations. It intuitively engages users, offering psychologist-informed music, arts, podcasts, and self-healing content. Users can continue the conversation on their mobile or web apps anytime, anywhere. For severe cases, it can link to local emergency suicide centers or mental health experts through telehealth if needed.

To address the above-mentioned problem. The primary objective of the invention is to establish a buddy chatbot that provides a secure and confidential platform for users to express their emotions and worries. Furthermore, the significance of early identification and intervention in addressing mental health matters can be recognized. The disclosed chatbot utilizes an ensemble model comprising ill-being detection and keyword recognition models to achieve this. This enables the chatbot to autonomously identify mental health-related concerns raised during conversations, delivering timely self-healing support and recommendations for resolution. A designed structured conversation flow that encourages users to express their emotions, thoughts, and experiences in a systematic and user-friendly manner by leveraging fine-tuned large language generative AI models like Chat Generative Pre-training Transformer (ChatGPT™). This approach helps users articulate their feelings effectively, facilitating a more productive conversation about their mental health in a natural way.

The disclosed chatbot stands out by incorporating an ensemble model comprising an ill-being detection model and an entity recognition model to automatically analyze the user's sentiment and context. This sophisticated approach allows the chatbot to early and accurately detect mental health-related concerns raised during conversation. The chatbot combines mental health detection, and conversation flow, and is powered by generative AI to make a natural conversation with the user, that can handle complex mental health concerns. Unlike some existing chatbots that offer generalized advice and support, the disclosed chatbot takes personalization to the next level. It recommends tailored mental health support resources based on the user's specific needs, identified issues, and personalized psychology. The disclosed chatbot prioritizes user confidentiality and security. It offers a safe space where users can freely share their emotions and concerns without fear of judgment or privacy breaches.

According to a first aspect of the invention, a method for supporting mental health using generative Artificial Intelligence (genAI) Chatbot is provided, the method comprises:
obtaining at least one message from a user;
designing a conversation flow from at least one message by detecting keyword(s) from each user's message and then defining guiding questions to encourage users to express their emotions, thoughts, and experiences in a systematic and user-friendly manner by leveraging fine-tuned large language generative AI models with prompt engineering techniques;
detecting the mental health issues based on the conversation flow by integrating an ill-being detection model and a keyword recognition model to identify conversations pertaining to mental health concerns, the conversation is considered as relating to mental health matters when a sentence within the conversation is flagged by the ill-being detection model or when there is an accumulation of negative keywords beyond a specified threshold within any given domain; and
giving recommendations on mental health support resources to the user based on the detected mental health issues,
wherein the ill-being detection model and keyword recognition model are developed by building pipeline and training Artificial Intelligence (AI) model with Bidirectional Encoder Representations from Transformers (BERT) models or pre-trained language model;
wherein the mental health support resources include Cognitive Behavioral Therapy (CBT) exercises, informative articles, inspiring movies, effective coping strategies, etc.

In this embodiment of the invention, the conversation flow was generated by leveraging fine-tuned large language generative Artificial Intelligence models like Chat Generative Pre-training Transformer (ChatGPT) with prompt engineering techniques and the predefined questions, assessment questions, user's answers analysis, and resource recommendation, to gain insight into the user's status and maintain a smooth conversation.

In this embodiment of the invention, the ill-being detection model identifies user sentences with negative emotions, while the keyword recognition model detects and categorizes positive and negative keywords across different mental domains by the BERT model.

According to a second aspect of the invention, a system for supporting mental health using generative Artificial Intelligence (genAI) Chatbot is provided, the system comprises:
an interactive platform where users can openly and comfortably share their moods;
a detection unit for detecting mental health issues from the user's conversation; and
a recommendation unit for giving recommendations on mental health support resources to the user,
wherein the interactive platform is configured to design a conversation flow by detecting keyword(s) from each user's message and then defining guiding questions to encourage users to express their emotions, thoughts, and experiences in a systematic and user-friendly manner by leveraging fine-tuned large language generative AI models with prompt engineering techniques;
wherein the detection unit is configured to detect mental health issues by integrating an ill-being detection model and a keyword recognition model to identify mental health concerns in the conversation input to the interactive platform, the conversation is considered as relating to mental health matters when a sentence within the conversation is flagged by the ill-being detection model or when there is an accumulation of negative keywords beyond a specified threshold within any given domain; and
wherein the recommendation unit comprises a database of mental health support resources including Cognitive Behavioral Therapy (CBT) exercises, informative articles, inspiring movies, effective coping strategies, etc., and is configured to give recommendations to the user based on the detected mental health issues.

In this embodiment of the invention, the system further comprises a summary unit that is configured to summarize each previous conversation, define prompts on the identity, intent, and behavior of the user in each previous conversation, and store the summarized conversation and the related prompts for using to respond to the new message of the user.

In this embodiment of the invention, the system further comprises a retrieving unit that is configured to retrieve information from trusted internet sources to enrich the chatbot's responses.

In this embodiment of the invention, the system further comprises a 24/7 counseling unit that is configured to allow users to connect with experienced psychologists whenever they require immediate assistance.

In this embodiment of the invention, the system further comprises a converter unit that is configured to convert speech-to-text and text-to-speech to enhance chatbot-user interactions through voice communication.

### BRIEF DESCRIPTIONS OF THE DRAWINGS

FIG. 1 is a block diagram illustrating of a chatbot system according to the present invention.

FIG. 2 is a schematic flowchart of the method for supporting mental health using generative Artificial Intelligence (genAI) Chatbot according to the present invention.

FIG. 3 is a diagram illustrating the overall algorithm of the proposed approach, illustrating the three primary layers of the chatbot system according to the present invention.

FIG. 4A and FIG. 4B illustrates a conversational flow of the chatbot system according to the present invention.

### DETAILED DESCRIPTION

While the invention may have various modifications and alternative forms, specific embodiments thereof are shown by way of example in the drawings and will be described herein in detail. However, the invention is not intended to be limited to the particular forms disclosed. The invention, on the other hand, is intended to cover all modifications, equivalents, and alternatives falling within the spirit and scope of the appended claims.

The terminology used herein is to describe particular embodiments only and is not intended to be limiting to the invention. As used herein, the singular forms “a” “an” “another” and “the” are intended to also include the plural forms, unless the context clearly indicates otherwise. Further, the plural forms are intended to include the singular forms as well, unless the context clearly indicates otherwise. It should be further understood that the terms “comprise” and/or “comprising” when used herein, specify the presence of stated features, integers, steps, operations, elements, parts, or combinations thereof, but do not preclude the presence or addition of one or more other features, integers, steps, operations, elements, parts, or combinations thereof.

In the present invention, the term “training/trained” or “learning/learned” may refer to performing machine learning through computing following a procedure. It will be appreciated by those skilled in the art that it is not intended to refer to a mental function such as human educational activity.

In the present invention, the term “chatbots” may be defined as text-based conversation agents that can interact with human users through some medium, such as an instant message service. Some chatbots are designed for specific purposes, while others converse with human users on a wide range of topics. It is understood that the invention is not limited to any particular type of chatbot in any particular field therein.

In the present invention, the term “conversation summary buffer memory” may refer to a temporary storage space within an AI system or chatbot, which holds a summarized version of the ongoing conversation with a user. This summary enables the AI to understand and recall the context of the conversation, allowing it to provide more accurate and relevant responses. The main components of this concept are: Conversation Summary refers to a concise representation of the conversation's main points, intents, and key pieces of information extracted from the user's input. It helps the AI to maintain context and provide coherent responses. Buffer refers to a temporary storage space where the conversation summary is held. This buffer is usually limited in size, so the AI continually updates and replaces the summary with the most relevant information from the conversation. Memory refers to the capacity of the AI to recall previously discussed topics, allowing it to provide context-aware responses. This memory typically includes both short-term and long-term memory components, enabling the AI to remember information within and across conversations. In summary, “conversation summary buffer memory” is a mechanism that allows AI systems and chatbots to maintain a contextual understanding of ongoing conversations, providing more accurate and coherent responses to user inputs.

In the present invention, the term “retrieves information” may describe the process of obtaining or accessing specific data or knowledge from a source. In the context of an AI assistant, this process involves searching through various sources, such as databases, websites, or internal knowledge bases, to find the requested information and deliver it to the user.

In the present invention, the term “prompt engineering” may be the process of structuring or designing a prompt that can be interpreted and understood by a generative AI model to yield desirable or useful results. A prompt is human-provided natural language text describing the task that an AI should perform.

In the present invention, the term “large language models” (LLMs) may be a type of artificial intelligence algorithm that uses deep learning techniques and massively large data sets to recognize, summarize, translate, predict, and generate new content.

In the present invention, the term “fine-tuning” may be an approach to transfer learning in which the weights of a pre-trained model are trained on new data. Fine-tuning can be done on the entire neural network, or only a subset of its layers, in which case the layers that are not being fine-tuned are frozen (not updated during the backpropagation step). Fine-tuning LLMs refers to the process of retraining a pre-trained language model on a specific task or dataset to adapt it for a particular application. It allows the system to harness the power of pre-trained language models for the exact needs without needing to train a model from scratch.

In the present invention, the term “units” may be hardware, software, or a combination thereof. For example, one or more of the units may be integrated circuits such as application-specific integrated circuits (ASICs), programmable logic devices (PLDs), or field-programmable gate arrays (FPGAs).

In the present invention, all terms including technical and scientific terms used herein have the same meaning as commonly understood by one of ordinary skill in the art to which this invention belongs, unless otherwise defined. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

One commonly used approach is rule-based systems. In this method, the chatbot may follow a predefined set of rules or pre-experiment questionnaires such as Patient Health Questionnaire 9 (PHQ-9), Depression Anxiety and Stress Scale 21 (DASS-21), and Job Satisfaction Survey (JSS) and respond to user inputs based on those rules. This approach is relatively simple to implement and can provide accurate responses if the rules are well-defined. However, rule-based systems can be limited in their ability to handle complex or nuanced conversations and may not be able to adapt to individual user needs.

Another approach is machine learning, specifically natural language processing (NLP) techniques. Machine learning algorithms can be trained on large datasets of conversations to learn patterns and generate appropriate responses. This approach allows the chatbot to understand and generate human-like responses. However, training machine learning models require a significant amount of annotated data and computational resources. Additionally, there is a risk of bias in the training data, which can lead to biased or inappropriate responses.

Hybrid approaches that combine rule-based systems with machine learning techniques can also be used. This approach may leverage the strengths of both methods, allowing for more flexibility and accuracy in responses. For example, a rule-based system can handle specific prompts or inquiries, while a machine-learning model can handle more open-ended conversations. Additionally, they use Cognitive Behavioral Therapy (CBT) principles for mental health support.

Sentiment analysis can assess the emotional state of users, enabling appropriate support. This technique helps identify users in distress and provide relevant resources or interventions. Sentiment generation can also ensure the chatbot responds compassionately and empathetically. While chatbots for mental health can offer valuable support and resources, it is essential to remember that they should never replace professional help.

There are a few well-known AI-based chatbots in the field of mental healthcare services, for example, Emohaa, Woebot™, Youper™, and Wysa™. Aside from the advantages that these programs provide, there are still several disadvantages that prevent them from effectively helping users with their mental problems, particularly when it comes to diagnosing users' complex emotional and mental health problems.

For example, Emohaa focused on analyzing users' emotions and providing personalized advice based on their emotional state. It utilizes template-based guided conversations for expressive writing and automatic thinking exercises; utilizes NLP techniques like tokenization, stemming, and lemmatization to interpret user inputs, identify emotions, and extract relevant information; provides real-time emotional support; provides personalized feedback and suggestions to improve emotional well-being. It relies on NLP algorithms, which may not accurately understand complex emotions and nuances in user responses; may not be able to engage in deep conversation; the chatbot's responses may lack the depth and understanding that can be provided by human therapists. Emohaa's responses are based on pre-defined conversation templates, which can make interactions feel less personalized or natural.

For another example, Woebot is another approach that delivers CBT and has demonstrated effectiveness across multiple studies in treating depression, anxiety, and substance use. It employs a rule-based dialogue manager to guide conversations and deliver appropriate CBT-based interventions with pre-built therapy sessions. It offers evidence-based techniques like CBT and dialectical behavior therapy (DBT) to help users manage stress, anxiety, and depression; daily check-ins and mood-tracking features allow users to monitor their emotional well-being over time. It is a frame-based conversational agent, i.e., the conversation flow itself is not static, but the user input fills out slots in a fixed template, which can make the conversation feel less natural. This approach lacks the ability to provide human connection, which might be essential for individuals seeking emotional support. Its diagnostic abilities are limited, and it may not recognize complex mental health conditions requiring professional intervention.

For another example, Youper is an AI-powered chatbot approach that focuses on emotional well-being and self-improvement. It employs techniques from various therapeutic approaches, such as CBT, mindfulness, and positive psychology, to address users' mental health concerns. That combines AI with techniques from CBT and mindfulness to provide individualized support for mental health challenges and guide meditation exercises to promote self-awareness and emotional well-being. It relies on self-reported data, which may affect the accuracy of its assessments and interventions. Youper is primarily focused on CBT and mindfulness and relies heavily on self-assessment questionnaires to tailor its recommendations, which can be time-consuming and may not always accurately represent an individual's needs.

For another example, Wysa is a chatbot that utilizes AI, natural language processing, and CBT techniques to provide mental health support, emotional support, and coping strategies with evidence-based techniques such as CBT, mindfulness, and meditation including cognitive restructuring, problem-solving, and behavioral activation, to help users manage their emotions and develop healthier thought patterns. It relies on scripted conversations and primarily uses CBT, which can limit its ability to address specific user concerns or adapt to their emotional states, occasional misinterpretation of user input, or limited ability to handle complex mental health concerns; relies on text-based communication, which may not be as engaging or effective as voice or video communication for some users.

Hereinafter, with reference to the accompanying figures, the invention describes a method and system for supporting mental health that uses a generative Artificial Intelligence (genAI) Chatbot to address the full spectrum of mental health concerns, from early detection of mental health issues to providing adequate mental health support solutions by utilizing natural language processing and deep learning techniques to understand and respond to users' emotions. Therefore, it can effectively support the users in resolving their mental health concerns.

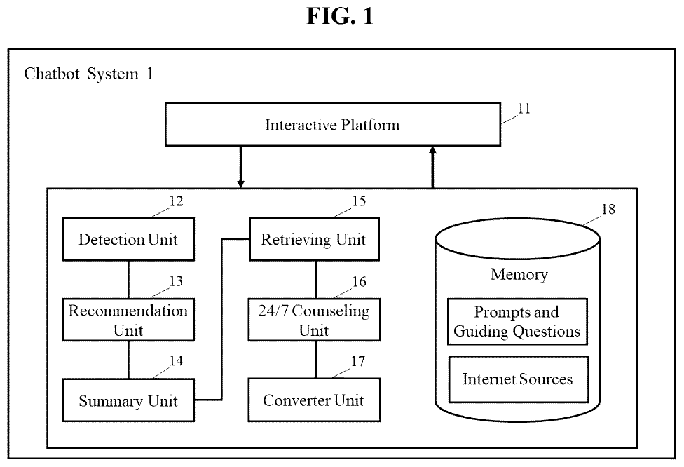

FIG. 1 is a block diagram illustrating of a chatbot system according to the present invention. The chatbot system 1 may comprise an interactive platform 11, a detection unit 12, a recommendation unit 13, a summary unit 14, a retrieving unit 15, a 24/7 counseling unit 16, a converter unit 17, and a memory 18.

The interactive platform 11 is where users can openly and comfortably share their moods, wherein the interactive platform 11 may be configured to design a conversation flow by detecting keyword(s) from each user's message and then defining guiding questions to encourage users to express their emotions, thoughts, and experiences in a systematic and user-friendly manner by leveraging fine-tuned large language generative AI models with prompt engineering techniques.

The detection unit 12 may detect mental health issues from the user's conversation, wherein the detection unit 12 may be configured to detect mental health issues by integrating an ill-being detection model and a keyword recognition model to identify mental health concerns in the conversation input to the interactive platform 11, the conversation is considered as relating to mental health matters when a sentence within the conversation is flagged by the ill-being detection model or when there is an accumulation of negative keywords beyond a specified threshold within any given domain.

The recommendation unit 13 may give recommendations on mental health support resources to the user, wherein the recommendation unit may comprise a database of mental health support resources including Cognitive Behavioral Therapy (CBT) exercises, informative articles, inspiring movies, effective coping strategies, etc., and is configured to give recommendations to the user based on the detected mental health issues.

The summary unit 14 may be configured to summarize each previous conversation, define prompts on the identity, intent, and behavior of the user in each previous conversation, and store the summarized conversation and the related prompts for use to respond to the new message of the user.

The retrieving unit 15 may be configured to retrieve information from trusted internet sources to enrich the chatbot's responses.

The 24/7 counseling unit 16 may be configured to allow users to connect with experienced psychologists whenever they require immediate assistance.

The converter unit 17 may be configured to convert speech-to-text and text-to-speech to enhance chatbot-user interactions through voice communication.

In addition, the system further comprises one or more memories 18, in which the memory 18 may be a storage or a volatile memory such as a random-access memory (RAM), or a non-volatile memory such as a read-only memory (ROM), a flash memory, a hard disk drive (HDD), or a solid-state drive (SSD), or a combination of the foregoing types of memories to temporary or permanent store data or programs (instructions). The memory 18 may be configured to store program instructions that can implement a method of the present invention.

It may be understood that the system structure shown in this present invention does not constitute a specific limitation on the chatbot system 1. In some other embodiments of this application, the chatbot system 1 may include more or fewer components than those shown in the figure, some components may be combined, or some components may be split, or different component arrangements may be used. The components shown in the figure may be implemented by hardware, software, or a combination of software and hardware.

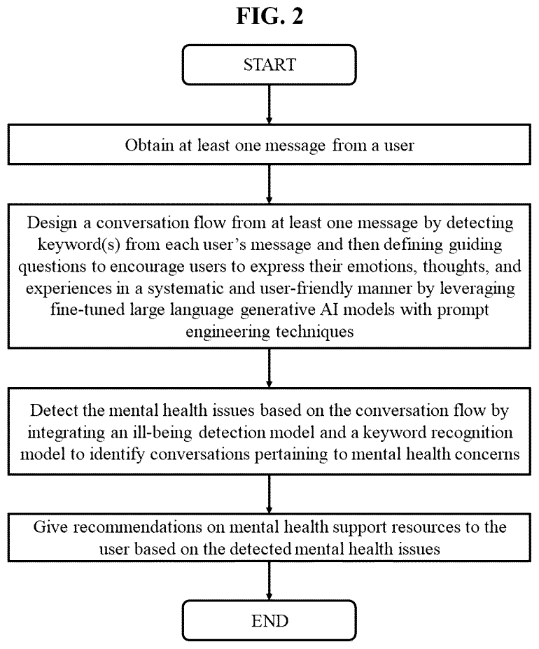

FIG. 2 is a schematic flowchart of the method for supporting mental health using generative Artificial Intelligence (genAI) Chatbot according to the present invention.

As illustrated in FIG. 2, the chatbot system 1 performs one or more of the following: obtaining at least one message from a user; designing a conversation flow from at least one message by detecting keyword(s) from each user's message and then defining guiding questions to encourage users to express their emotions, thoughts, and experiences in a systematic and user-friendly manner by leveraging fine-tuned large language generative AI models with prompt engineering techniques; detecting the mental health issues based on the conversation flow by integrating an ill-being detection model and a keyword recognition model to identify conversations pertaining to mental health concerns, the conversation is considered as relating to mental health matters when a sentence within the conversation is flagged by the ill-being detection model or when there is an accumulation of negative keywords beyond a specified threshold within any given domain; and giving recommendations on mental health support resources to the user based on the detected mental health issues.

The ill-being detection model and keyword recognition model are developed by building pipeline and training Artificial Intelligence (AI) models with Bidirectional Encoder Representations from Transformers (BERT) models or pre-trained language models.

The mental health support resources include Cognitive Behavioral Therapy (CBT) exercises, informative articles, inspiring movies, effective coping strategies, etc.

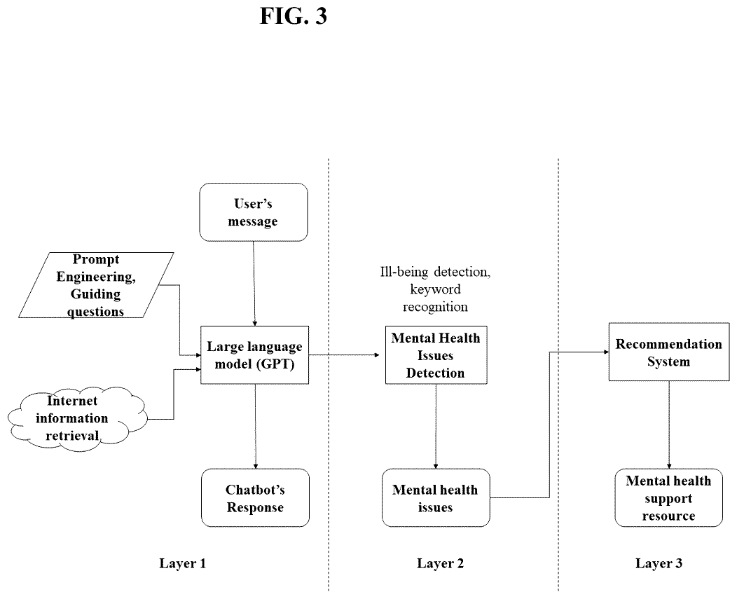

FIG. 3 is a diagram illustrating the overall algorithm of the proposed approach, illustrating the three primary layers of the chatbot system. This diagram depicts the overall algorithm of our proposed approach, illustrating the three primary layers of the chatbot system. In Layer 1, a chatbot with conversation flow, starting with the user's message, the large language generative AI model-ChatGPT is employed, along with prompt engineering, guiding questions, and retrieval of information to generate chatbot responses for users. Layer 2, an auto-detection of mental health issues step, is responsible for automatically detecting mental health issues within the conversational dialog created by Layer 1. Subsequently, Layer 3, an auto-recommendation mental health support resources step, utilizes context extracted by Layer 2 to provide recommendations for mental health support resources.

In an embodiment, the disclosed chatbot for mental health is equipped with three core layers: chatbot with conversation flow; auto-detection of mental health issues; and auto-recommendation of mental health support resources.

The first layer of this innovative chatbot focuses on providing a platform where users can openly and comfortably share their moods. This safe and non-judgmental environment allows individuals to articulate their emotions, fostering self-awareness and emotional well-being.

This layer indicates a designed conversation flow that encourages users to share their emotions, thoughts, and experiences in a structured manner. This flow is user-friendly and intuitive, making it easy for users to open up about their mental health. In the conversational flow, users interact with the chatbot naturally, which encourages users to express their emotions, thoughts, and experiences in a systematic and user-friendly manner by leveraging fine-tuned large language generative AI model-ChatGPT alongside prompt engineering and our predefined questions, assessment questions, and resource recommendation to gain insight into the user's status and maintain a smooth conversation. The conversational flow demonstrates the interaction process of the chatbot system with users, including steps such as keyword detection, guiding questions, DASS examination, natural conversational responses, and recommendations. This approach helps users articulate their feelings effectively, facilitating a more productive conversation about their mental health in a natural way. The detail of the conversational flow is depicted in the description and figure below.

Leveraging the formidable capabilities of large language generative AI model ChatGPT, prompt engineering can be a highly effective method for enhancing performance and generating outputs tailored to specific desired outcomes. In this approach, the carefully crafted prompts for ChatGPT ensure that the chatbot engages with users as virtual friends, particularly within the context of mental health support. These prompts encompass three primary aspects: identity, intent, and behavior.

Identity serves as a guiding principle, defining the chatbot's role as a virtual friend to whom users can comfortably confide their emotions and moods. The intent of the chatbot is centered on fostering a cheerful and humorous disposition while being an attentive and empathetic listener. Moreover, the behavior aspect delineates the chatbot's functions, which include sharing the user's feelings, expressing empathy, and offering encouragement.

The use of pure ChatGPT can lead to an endless loop or a directionless exploration of the user's psychology. Therefore, it is essential to incorporate well-designed preset inquiries. Guiding questions come in three forms: open-ended questions, direct questions, and navigational questions. Open-ended questions are introduced during interactions when the chatbot conversation seems to be becoming one-sided. Direct questions are employed when the user divulges content relevant to their psychological concerns. In contrast, navigational questions serve as a means to smoothly shift the conversation towards exploring different facets of the user's psychology. The guiding questions are appropriately integrated into the flow to ensure the consistency and smoothness of the conversation.

The chatbot's memory also determines the coherence of the conversation. To address this issue, a conversation summary buffer memory is implemented to enhance the chatbot's memory capacity. The conversation summary buffer memory operates on the principle that each batch of previous conversations is summarized. The prompt will contain the most recent conversations along with summaries of the history, which are used to respond to the user's current query.

Since the ChatGPT model cannot update real-time information, its responses may not be accurate and can potentially lead to confusion. To enrich the chatbot's responses, a unit is implemented to retrieve information from trusted internet sources. This feature provides users with accurate and up-to-date information and reduces hallucination responses. To assess the user's mental health, the Depression Anxiety Stress Scale-21 (DASS-21) examination questions are implemented into our conversation. The DASS-21 is a commonly employed psychological self-report assessment tool that is specifically designed to gauge the levels of depression, anxiety, and stress experienced by individuals.

The second layer of the chatbot integrates an ill-being detection model and a keyword recognition model to identify conversations on mental health concerns. The ill-being detection model is responsible for identifying user sentences with negative emotions, while the keyword recognition model is tasked with detecting and categorizing positive and negative keywords across different mental domains. By leveraging advanced natural language processing and deep learning algorithms, the second layer of the chatbot is engineered to auto-detect potential mental health issues in user conversations. Recognizing subtle cues and patterns in dialogue can identify when users may be struggling with mental health challenges, even if they have not explicitly articulated them.

A conversation related to mental health matters is identified when a sentence within the conversation is flagged by the ill-being detection model or when there is an accumulation of negative keywords beyond a specified threshold within any given domain.

The Bidirectional Encoder Representations from Transformers (BERT) model is applied to develop both the ill-being detection model and the keyword recognition model. BERT's architecture is specifically designed to comprehend the contextual significance of words within a sentence by simultaneously considering both left and right contextual information, in contrast to conventional models that only account for unidirectional context.

The pre-trained Phobert-large model, which has 370 million parameters and is one of the best pre-trained BERT models for the Vietnamese language, is utilized to fine-tune both tasks. To detect and classify a keyword belonging to a specific mental domain, it is necessary to use the context of related conversations. Therefore, the input for the keyword recognition model consists of several turns of conversation, not just a single sentence. This presents a greater challenge when compared to keyword recognition in other tasks.

The ill-being detection model is fine-tuned on a dataset to be used as a training set comprising 28,433 samples labeled with binary classes. The model's performance was validated on 1,514 samples, resulting in an F1-score of 77.4%. Besides, the keyword recognition model was trained with a dataset of 17,784 samples. Its performance was evaluated on 2,000 samples, and it achieved a remarkable F1-score of 88%. The entire training, evaluation, testing, and inference processes for these models were implemented using PyTorch and executed on an A100 GPU. During training, the Adam optimizer is employed with a learning rate of 5×10\hat{ }−5 and a linear decay scheduler for 30 epochs. Training time averaged 3 minutes per epoch, while inference time was a mere 0.03 seconds per sample.

The third layer of the chatbot indicates that the Mental Health Support Resource Recommendation component stands as the pivotal third layer within the comprehensive approach. This layer is designed to offer tailored assistance to users seeking help with their mental health concerns, ensuring they receive the most relevant and beneficial support. The system's recommendation engine operates seamlessly, drawing upon information from both the Mental Health Issue Detection layer and the ongoing conversation context to precisely suggest the ideal support resources.

Once a potential mental health concern is identified, This layer automatically recommends a personalized self-help library or an appropriate psychologist for each user. These resources encompass a wide array of tools and materials, meticulously curated to cater to the unique needs and challenges faced by each individual. They include CBT exercises, informative articles, inspiring movies, and effective coping strategies. Our goal is to provide users with a versatile toolkit for managing their mental health effectively, making their journey to wellness as smooth as possible.

One of the standout features of the invention is the inclusion of a 24/7 counseling system, allowing users to connect with experienced psychologists whenever they require immediate assistance. These psychologists have been carefully selected, ensuring they possess at least a decade of hands-on experience in the field. Moreover, the recommendation algorithm takes into account the psychologist's expertise, matching them with the user whose needs and concerns align most closely. This way, it is ensured that the recommended psychologist has dealt extensively with issues similar to those the current user is facing, increasing the likelihood of a successful and fruitful therapeutic relationship.

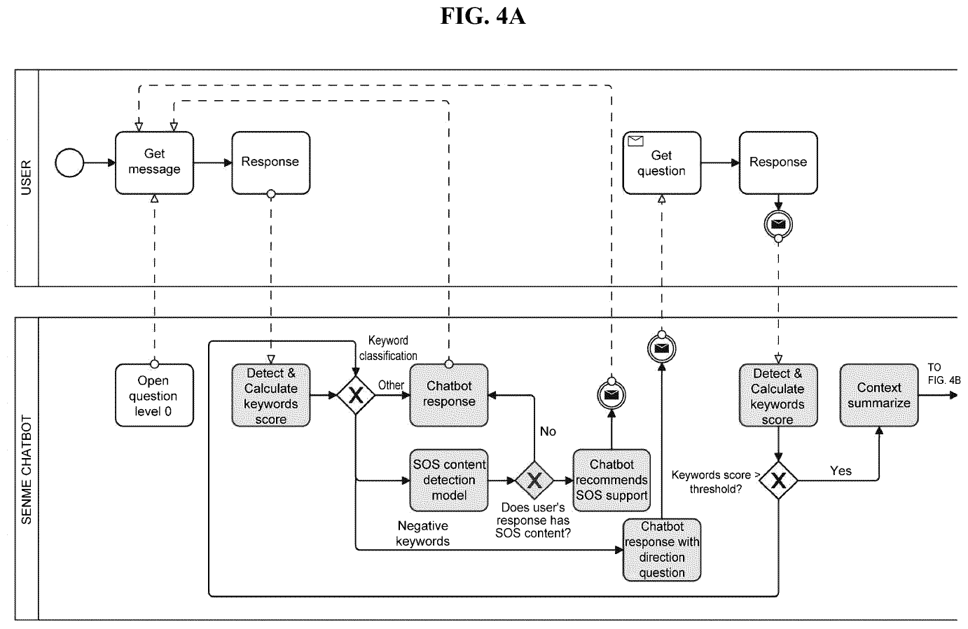

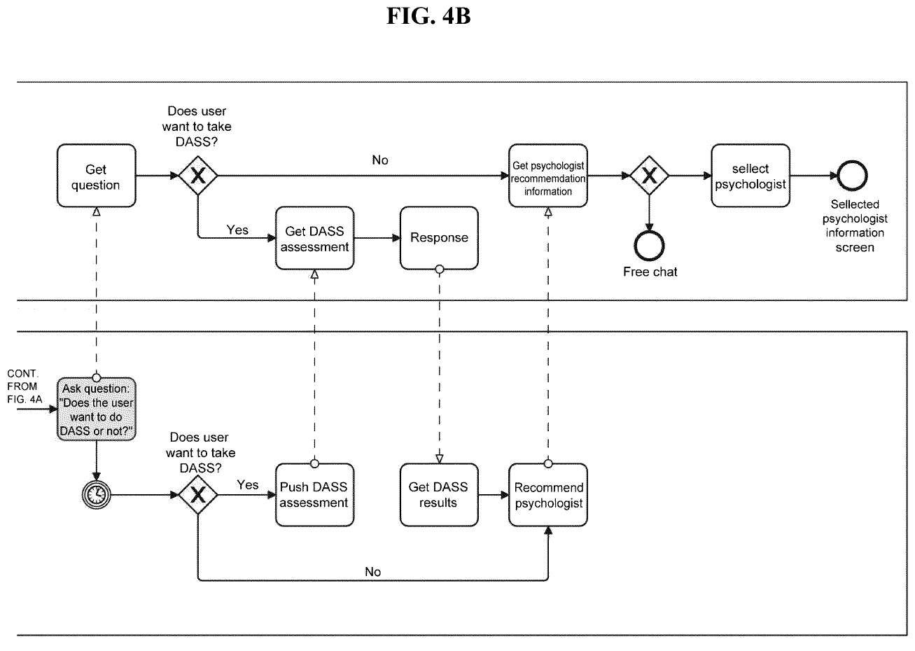

FIG. 4A and FIG. 4B illustrates the conversational flow of the disclosed chatbot system. These figures display the conversational flow of the chatbot as being performed by a system of one or more computers and the system for mental health issues recognition and recommendation. In FIG. 4A, users interact with the chatbot naturally, leveraging the fine-tuned large language generative AI model-ChatGPT alongside prompt engineering and our predefined questions, assessment questions, user's answers analysis, and resource recommendation to gain insight into the user's status and maintain a smooth conversation. The conversational flow demonstrates the interaction process of the chatbot system with users, including steps such as keyword detection and analysis, guiding questions, DASS examination, natural conversational responses, and recommendations.

In the initial step, users interact with the chatbot naturally by answering the open questions from the chatbot system, users send messages via their personal devices or personal digital assistants (such as mobile phones, cell phones, smartphones, personal computers, tablet computer, laptop, smartwatch, smart glasses, . . . ) to the chatbot system. After receiving messages from the users, the chatbot system leveraging the fine-tuned large language generative AI model-ChatGPT alongside prompt engineering and the predefined questions, assessment questions, user's answers analysis, and resource recommendations to gain insight into the user's status and maintain a smooth conversation.

In the next step, the chatbot system detects and calculates the keyword score using an ill-being detection model and a keyword recognition model to identify conversations pertaining to mental health concerns. The ill-being detection model is responsible for identifying user sentences with negative emotions, while the keyword recognition model is tasked with detecting and categorizing positive and negative keywords across different mental domains. In this step, the chatbot system classifies the keywords and identifies the sentences from the user messages to determine whether there are any negative keywords or any mental health-related sentences. If this is not the case, the chatbot system will send response messages to the users' devices. If negative keywords are identified, the chatbot system determines to send a direction question to the users in order to express empathy and offer encouragement to the user's psychological concerns. If mental health-related sentences are identified, the chatbot system will promptly provide the users with the mental health support resources that they require to assist them in effectively managing their mental health and helping them recover quicker. If SOS content is identified from the users' messages, the chatbot system will promptly recommend users with SOS support or mental health support resources.

In a further step, when the users receive a direction question from the chatbot system about their psychological concerns and decide to respond to it, the chatbot system detects and calculates the keywords score again and determines whether the keywords score is higher than the threshold. If the keywords score is lower or equal to the threshold, the chatbot system determines to go to the keyword classification step. If the keyword score is higher than the threshold, the chatbot system determines to summarize the context of the messages. Subsequently, in FIG. 4B, the chatbot system asks the users a guiding question on whether or not they want to do DASS. If the user takes the DASS examination as recommended, the chatbot system with provide them with the DASS assessment, and the users will get the assessment on their personal device. When the users complete the examination, they send it back to the chatbot system, and with the DASS results from the users, the chatbot system can analyze their mental health to recognize any mental health issues if there are and recommend them to the most appropriate psychologist. The users are then given the psychologists' recommendations and information about their mental health issues, and they are allowed to connect with these psychologists whenever they require immediate assistance. If the users find that the assigned psychologists are not appropriate for their mental health issues, they are allowed to select other psychologists from the psychologists' information screen provided by the chatbot system to find the most appropriate psychologists to help the users effectively with their issues and increase the likelihood of a successful and fruitful therapeutic relationship.

The above descriptions are merely illustrative of the technical ideas of the present invention, and those skilled in the art of the present invention can make various modifications and changes without departing from the scope of the present invention. Therefore, the embodiments disclosed in the invention are not intended to limit the scope of the invention but to illustrate the invention, and the scope of the invention is not limited by these embodiments. The scope of the invention should be understood in accordance with the claims below, and such modifications and changes should be considered within the scope of the invention.

### EXAMPLES

A dataset has been compiled comprising 1104 user interactions and the SenMe™ chatbot. This dataset encompasses 1104 conversations, encompassing 60,292 individual chat turns. Each conversation consists of at least two chat turns, with a maximum of 826. Psychologists have classified every conversation into two categories: those involving individuals with mental health issues and those without. The dataset comprises 397 conversations marked as positive (indicating mental health issues) and 707 conversations without such concerns. The effectiveness of the approach's performance is assessed using various threshold values for the number of keywords within the dataset.

The pre-trained Phobert-large model is utilized to train the ill-being detection model on a dataset comprising 28,433 samples. The model's performance was assessed on 1,514 samples, resulting in an impressive F1-score of 77.4%. Besides that, the keyword recognition model is finetuned on a dataset of 17,784 samples. Its performance was evaluated on 2,000 samples, and it achieved a remarkable F1-score of 88%.

| Threshold | Accuracy (%) | Recall (%) | Precision | F1_score |
|---|---|---|---|---|
| 2 | 74.8 | 85.9 | 60.5 | 71.0 |
| 3 | 78.4 | 82.9 | 65.9 | 73.4 |
| 4 | 80.2 | 82.9 | 68.5 | 75.0 |
| 5 | 71.1 | 57.7 | 60.2 | 58.9 |

The effectiveness of the approach's performance is evaluated for mental health issue detection on the real conversation dataset, with a threshold of 4, the proposed approach yielded the optimal outcome, achieving an accuracy rate of 80.2%, recall=82.9%, and precision=68.5%.
Confusion matrix:
Threshold=4;

| | Predicted: No | Predicted: Yes |
|---|---|---|
| Label: No | 556 | 151 |
| Label: Yes | 68 | 329 |

The approach is evaluated by a satisfaction rate of 2575 users, which is based on the data of 60292 messages from user interaction conversations with a retention rate of 18% and a satisfaction rating point of 4.26/5, which can be considered as well evaluated and highly promising.

| Items | Values |
|---|---|
| Participant | 2575 |
| Message | 60292 |
| Retention | 18% |
| Satisfaction rating point | 4.26/5 |

1. A method for supporting mental health using generative Artificial Intelligence (genAI) Chatbot, the method comprising:
obtaining at least one message from a user;
designing a conversation flow from at least one message by detecting keyword(s) from each user's message and then defining guiding questions to encourage users to express their emotions, thoughts, and experiences in a systematic and user-friendly manner by leveraging fine-tuned large language generative AI models with prompt engineering techniques;
detecting the mental health issues based on the conversation flow by integrating an ill-being detection model and a keyword recognition model to identify conversations pertaining to mental health concerns, the conversation is considered as relating to mental health matters when a sentence within the conversation is flagged by the ill-being detection model or when there is an accumulation of negative keywords beyond a specified threshold within any given domain; and
giving recommendations on mental health support resources to the user based on the detected mental health issues,
wherein the ill-being detection model and keyword recognition model are developed by building pipeline and training Artificial Intelligence (AI) models with Bidirectional Encoder Representations from Transformers (BERT) models or pre-trained language models;
wherein the mental health support resources include Cognitive Behavioral Therapy (CBT) exercises, informative articles, inspiring movies, effective coping strategies, etc.

2. The method of claim 1, wherein the conversation flow was generated by leveraging fine-tuned large language generative Artificial Intelligence models with prompt engineering techniques and the predefined questions, assessment questions, user's answers analysis, and resource recommendation, to gain insight into the user's status and maintain a smooth conversation.

3. The method of claim 1, wherein the ill-being detection model identifies user sentences with negative emotions, while the keyword recognition model detects and categorizes positive and negative keywords across different mental domains by the BERT model.

4. A system for supporting mental health using generative Artificial Intelligence (genAI) Chatbot, the system comprising:
an interactive platform where users can openly and comfortably share their moods;
a detection unit for detecting mental health issues from the user's conversation; and
a recommendation unit for giving recommendations on mental health support resources to the user,
wherein the interactive platform is configured to design a conversation flow by detecting keyword(s) from each user's message and then defining guiding questions to encourage users to express their emotions, thoughts, and experiences in a systematic and user-friendly manner by leveraging fine-tuned large language generative AI models with prompt engineering techniques;
wherein the detection unit is configured to detect mental health issues by integrating an ill-being detection model and a keyword recognition model to identify mental health concerns in the conversation input to the interactive platform, the conversation is considered as relating to mental health matters when a sentence within the conversation is flagged by the ill-being detection model or when there is an accumulation of negative keywords beyond a specified threshold within any given domain; and
wherein the recommendation unit comprises a database of mental health support resources including Cognitive Behavioral Therapy (CBT) exercises, informative articles, inspiring movies, effective coping strategies, etc., and is configured to give recommendations to the user based on the detected mental health issues.

5. The system of claim 4, further comprises a summary unit that is configured to summarize each previous conversation, define prompts on the identity, intent, and behavior of the user in each previous conversation, and store the summarized conversation and the related prompts for use to respond to the new message of the user.

6. The system of claim 4, further comprises a retrieving unit that is configured to retrieve information from trusted internet sources to enrich the chatbot's responses.

7. The system of claim 5, further comprises a retrieving unit that is configured to retrieve information from trusted internet sources to enrich the chatbot's responses.

8. The system of claim 4, further comprises a 24/7 counseling unit that is configured to allow users to connect with experienced psychologists whenever they require immediate assistance.

9. The system of claim 5, further comprises a 24/7 counseling unit that is configured to allow users to connect with experienced psychologists whenever they require immediate assistance.

10. The system of claim 4, further comprises a converter unit that is configured to convert speech-to-text and text-to-speech to enhance chatbot-user interactions through voice communication.

11. The system of claim 5, further comprises a converter unit that is configured to convert speech-to-text and text-to-speech to enhance chatbot-user interactions through voice communication.
